(19) United States
(12) Patent Application Publication
(10) Pub. No.: US 2012/0013050 A1
(43) Pub. Date: Jan. 19, 2012

(54) Method of manufacturing a non-aqueous electrolyte secondary battery

(76) Inventors: Chihiro Yada, Susono City (JP); Fumiharu Niina, Kobe City (JP); Hiroshi Nakagawa, Saku-City (JP); Hiroyuki Fujimoto, Kobe City (JP)

(21) Appl. No.: 13/200,339

(22) Filed: Sep. 23, 2011

Related U.S. Application Data
(62) Division of application No. 12/379,483, filed on Feb. 23, 2009.

(30) Foreign Application Priority Data
Feb. 22, 2008 (JP) 40915/2008
Jul. 11, 2008 (JP) 180918/2008

(51) Int. Cl. C04B 35/64

(52) U.S. Cl. 264/618

(57) ABSTRACT

A non-aqueous electrolyte secondary battery having a positive electrode (11) containing a positive electrode active material, a negative electrode (12) containing a negative electrode active material, and a non-aqueous electrolyte solution (14) in which a solute is dissolved in a non-aqueous solvent. The positive electrode active material is obtained by sintering a titanium-containing oxide on a surface of a layered lithium-containing transition metal oxide represented by the general formula Li₁₊ₓNiₐMn_{b}Co_{c}O_{2+d}, where x, a, b, c, and d satisfy the conditions x+a+b+c=1, 0.7≦a+b, 0<x≦0.1, 0≦c/(a+b)<0.35, 0.7≦a/b≦2.0, and −0.1≦d≦0.1.

This application is a division of application Ser. No. 12/379,483, filed Feb. 23, 2009, which claims priority based on Japanese Patent Application Nos. 2008-40915 and 2008-180918, filed Feb. 22, 2008, and Jul. 11, 2008, respectively, and which are incorporated herein by reference.

### BACKGROUND OF THE INVENTION

1. Field of the Invention

The present invention relates to a non-aqueous electrolyte secondary battery comprising a positive electrode containing a positive electrode active material, a negative electrode containing a negative electrode active material, and a non-aqueous electrolyte in which a solute is dissolved in a non-aqueous solvent, and a method of manufacturing the battery. More particularly, the invention relates to improvements in the positive electrode active material of a non-aqueous electrolyte secondary battery having a positive electrode active material comprising a layered lithium-containing transition metal oxide in which the transition metal main components comprise two elements, nickel and manganese, and which is low in cost. The non-aqueous electrolyte secondary battery exhibits improvements in the charge-discharge characteristics over a wide range of state of charge, especially the charge characteristics at high state of charge, so that the battery can be suitably used as a power supply for hybrid electric vehicles and the like.

2. Description of Related Art

Significant size and weight reductions in mobile electronic devices such as mobile telephones, notebook computers, and PDAs have been achieved in recent years. In addition, power consumption of such devices has been increasing as the number of functions of the devices has increased. As a consequence, demand has been increasing for lighter weight and higher capacity non-aqueous electrolyte secondary batteries used as power sources for such devices.

In recent years, development of HEVs (Hybrid Electric Vehicles), which use electric motors in conjunction with automobile gasoline engines, has been in progress in order to resolve the environmental issues arising from vehicle emissions.

Nickel-metal hydride storage batteries have been widely used as commonly used power sources for such electric vehicles, but the use of non-aqueous electrolyte secondary batteries has been studied to achieve higher capacity and higher power sources.

In the non-aqueous electrolyte secondary batteries, the positive electrode commonly comprises a positive electrode active material that employs a lithium-containing transition metal oxide, such as lithium cobalt oxide (LiCoO₂), which contains cobalt as a main component.

However, there have been some problems with this type of non-aqueous electrolyte secondary battery. For example, since the positive electrode active material contains scarce natural resources such as cobalt, the cost tends to be high and a stable supply is difficult. In particular, when the battery is used as the power source for an electric vehicle, a large amount of cobalt is necessary, so the power source accordingly becomes very costly.

For these reasons, a positive electrode active material that employs nickel or manganese as the main material in place of cobalt has been studied to obtain a positive electrode that is less costly and can be supplied more stably.

For example, layered lithium nickel oxide (LiNiO₂) is expected to be a material that achieves a high discharge capacity. However, it has drawbacks of high overvoltage as well as poor safety because of its low thermal stability.

Spinel-type lithium manganese oxide (LiMn₂O₄) has an advantage of low cost because of its abundance as a natural resource, but it has drawbacks of low energy density and dissolution of the manganese into the non-aqueous electrolyte solution under high temperature environment.

For these reasons, a layered lithium-containing transition metal oxide in which the main components of the transition metals are two elements, nickel and manganese, has drawn attention in recent years from the viewpoint of its low cost and good thermal stability.

For example, Japanese Published Unexamined Patent Application No. 2007-12629 proposes a lithium-containing composite oxide that can be used as a positive electrode active material that has almost the same level of energy density as lithium cobalt oxide but does not suffer from safety degradation, unlike lithium nickel oxide, or dissolution of manganese in the non-aqueous electrolyte solution under high temperature environment, unlike lithium manganese oxide. The lithium-containing composite oxide has a layered structure and contains nickel and manganese. It has a rhombohedral structure and the error of the ratio of nickel and manganese is less than 10 atomic %.

However, the lithium-containing transition metal oxide disclosed in the just-mentioned publication has the problem of considerably poorer high-rate charge-discharge capability than lithium cobalt oxide, so it is difficult to use it as a power source for electric vehicles and the like.

Japanese Patent No. 3571671 proposes a layered lithium-containing transition metal oxide containing at least nickel and manganese that is a single phase cathode material in which part of the nickel and the manganese is substituted by cobalt.

However, the single phase cathode material disclosed in Japanese Patent No. 3571671 has the problem of high cost as described above when the amount of cobalt that substitutes part of the nickel and the manganese is large. On the other hand, it shows considerably poor high-rate charge-discharge capability when the amount of cobalt that substitutes part of the nickel and the manganese is small.

Japanese Published Unexamined Patent Application No. 2005-346956 proposes a positive electrode active material in which a composite oxide having a layered structure contains lithium and a transition metal including nickel and manganese, and the transition metal is surface modified with a compound (stearate) of a metal such as Al, Mg, Sn, Ti, Zn, and Zr, for the purposes of reducing the internal resistance of a non-aqueous electrolyte secondary battery and improving high-rate charge-discharge capability.

Even with the positive electrode active material disclosed in Japanese Published Unexamined Patent Application No. 2005-346956, the high-rate charge-discharge capability cannot be improved sufficiently. In particular, the resistance of the material is nonetheless high during charge at a high state of charge, and therefore, in the case of using the battery as a power source for an electric vehicle, it is impossible to use the kinetic energy produced when a vehicle is braked and decelerated, i.e., the regenerative brake energy, efficiently for charging the battery.

Japanese Patent No. 3835412 proposes a positive electrode active material manufactured by allowing niobium oxide or titanium oxide to exist on a surface of a lithium-nickel composite oxide and sintering the lithium-nickel composite oxide, for the purpose of enhancing thermal stability of the material.

Even with the positive electrode active material disclosed in Japanese Patent No. 3835412, the same problems arise as described above in the case of the positive electrode active material disclosed in Japanese Published Unexamined Patent Application No. 2005-346956. Specifically, the high-rate charge-discharge capability cannot be improved sufficiently. In particular, the resistance of the material is high during charge at a high state of charge, so the regenerative brake energy cannot be used efficiently for charging the battery, and therefore, the battery cannot be used suitably as a power source for electric vehicles.

### BRIEF SUMMARY OF THE INVENTION

It is an object of the present invention to solve the foregoing and other problems in the non-aqueous electrolyte secondary battery comprising a positive electrode containing a positive electrode active material, a negative electrode containing a negative electrode active material, and a non-aqueous electrolyte solution in which a solute is dissolved in a non-aqueous solvent.

Specifically, it is an object of the present invention to provide a non-aqueous electrolyte secondary battery that employs as a positive electrode active material a low-cost lithium-containing transition metal oxide having a layered structure in which the transition metal main components are composed of two elements, nickel and manganese, the positive electrode active material achieving improvements in charge-discharge characteristics over a wide range of state of charge, particularly charge characteristics at a high state of charge, so that it can be used suitably for a power source for hybrid electric vehicles and the like.

In order to accomplish the foregoing and other objects, the present invention provides a non-aqueous electrolyte secondary battery comprising: a positive electrode containing a positive electrode active material; a negative electrode containing a negative electrode active material; and a non-aqueous electrolyte solution in which a solute is dissolved in a non-aqueous solvent, wherein the positive electrode active material is obtained by sintering a titanium-containing oxide on a surface of a layered lithium-containing transition metal oxide represented by the general formula Li₁₊ₓNiₐMn_{b}Co_{c}O_{2+d}, wherein x, a, b, c, and d satisfy the following conditions x+a+b++c=1, 0.7≦a+b, 0<x≦0.1, 0≦c/(a+b)<0.35, 0.7≦a/b≦2.0, and −0.1≦d≦0.1.

In the non-aqueous electrolyte secondary battery of the present invention, the positive electrode active material is one that is obtained by sintering a titanium-containing oxide on a surface of a layered lithium-containing transition metal oxide represented by the general formula Li₁₊ₓNiₐMn_{b}Co_{c}O_{2+d}, wherein x+a+b+c=1, 0.7≦a+b, 0<x≦0.1, 0≦c/(a+b)<0.35, 0.7≦a/b≦2.0, and −0.1≦d≦0.1, as described above. Therefore, the interface between the positive electrode and the non-aqueous electrolyte solution is modified so that charge transfer reactions are promoted. As a result, the charge-discharge characteristics are improved over a wide range of state of charge, especially at a high state of charge.

As a result, the non-aqueous electrolyte secondary battery according to the present invention exhibits improved charge-discharge characteristics over a wide range of state of charge, especially the charge characteristics at a high state of charge, so the non-aqueous electrolyte secondary battery can be used suitably as a power source for hybrid electric vehicles and the like.

### BRIEF DESCRIPTION OF THE DRAWINGS

FIG. 1 is a scanning electron micrograph showing the condition of the positive electrode active material prepared in the manner described in Example 1 of the invention;

FIG. 2 is a schematic illustrative drawing of a three-electrode test cell that uses, as the working electrode, a positive electrode fabricated according to the examples of the invention and the comparative examples;

FIG. 3 is a scanning electron micrograph showing the condition of the positive electrode active material prepared in the manner described in Example 2 of the invention;

FIG. 4 is a scanning electron micrograph showing the condition of the positive electrode active material prepared in the manner described in Comparative Example 1; and

FIG. 5 is a scanning electron micrograph showing the condition of the positive electrode active material prepared in the manner described in Comparative Example 3.

### DETAILED DESCRIPTION OF THE INVENTION

A non-aqueous electrolyte secondary battery according to the invention comprises a positive electrode containing a positive electrode active material, a negative electrode containing a negative electrode active material, and a non-aqueous electrolyte solution in which a solute is dissolved in a non-aqueous solvent. The positive electrode active material is obtained by sintering a titanium-containing oxide on a surface of a layered lithium-containing transition metal oxide represented by the general formula Li₁₊ₓNiₐMn_{b}Co_{c}O_{2+d}, wherein x, a, b, c, and d satisfy the following conditions x+a+b+c=1, 0.7≦a+b, 0<x≦0.1, 0≦c/(a+b)<0.35, 0.7≦a/b≦2.0, and −0.1≦d≦0.1.

In the lithium-containing transition metal oxide, the composition ratio c of cobalt Co, the composition ratio a of nickel Ni, and the composition ratio b of manganese Mn should satisfy the condition 0≦c/(a+b)<0.35 because, in order to reduce the material cost, the proportion of cobalt needs to be low. The present invention is characterized in that the charge-discharge characteristics over a wide range of state of charge, particularly the charge characteristics at a high state of charge, are improved in the non-aqueous electrolyte secondary battery that employs, as a positive electrode active material, such a lithium-containing transition metal oxide that has a low cobalt proportion and is low in cost.

In the lithium-containing transition metal oxide, the composition ratio a of nickel Ni and the composition ratio b of manganese Mn should satisfy the condition 0.7≦a/b≦2.0. The reason is as follows. When the value a/b exceeds 2.0 and accordingly the proportion of Ni is large, the thermal stability of the lithium-containing transition metal oxide becomes considerably poor. Consequently, the temperature at which the heat generation reaches a peak is lowered, and safety is extremely degraded. On the other hand, when the value a/b is less than 0.7, the proportion of Mn is large. Consequently, an impurity layer is formed and the capacity is lowered. Thus, in order to enhance the thermal stability and minimize the capacity deterioration at the same time, it is preferable to use a lithium-containing transition metal oxide that satisfies the condition 0.7≦a/b≦1.5.

In the above-described lithium-containing transition metal oxide, the value x in the composition ratio (1+x) of lithium Li should satisfy the condition 0<x≦0.1. The reason is as follows. When 0<x, the output power characteristics improve. However, when x>0.1, the amount of the alkali that remains on the surface of the lithium-containing transition metal oxide is large, causing gelation of the slurry used in the process of fabricating the battery, and the amount of the transition metal involved in the oxidation-reduction reaction also reduces, resulting in a low capacity. It is more preferable to use a lithium-containing transition metal oxide that satisfies the condition 0.05≦x≦0.1.

In the above-described lithium-containing transition metal oxide, the value d in the composition ratio (2+d) of oxygen O should satisfy the condition −0.1≦d≦0.1. The reason is that the lithium-containing transition metal oxide should be prevented from an oxygen shortage state or an oxygen excess state and the crystal structure should be prevented from being damaged.

As described above, the present invention employs a positive electrode active material in which a titanium-containing oxide is sintered on a surface of the lithium-containing transition metal oxide. Therefore, by the titanium-containing oxide sintered on the surface of the lithium-containing transition metal oxide, the interface between the positive electrode and the non-aqueous electrolyte solution is believed to be modified, and thereby the charge transfer reaction is promoted. As a result, the charge-discharge characteristics over a wide range of state of charge, particularly the charge characteristics at high state of charge, can be improved significantly.

In the positive electrode active material of the present invention, the advantageous effects resulting from the titanium-containing oxide cannot be obtained sufficiently if the amount of the titanium-containing oxide sintered on the surface of the lithium-containing transition metal oxide is small. On the other hand, if the amount of the titanium-containing oxide is too large, the characteristics of the lithium-containing transition metal oxide become poor. It is therefore preferable that the amount of titanium on the positive electrode active material, in terms of titanium in the titanium-containing oxide, be from 0.05 mass % to 0.5 mass %.

The type of the titanium-containing oxide to be sintered on a surface of the lithium-containing transition metal oxide is not particularly limited. However, it is preferable that the titanium-containing oxide be a lithium-titanium oxide or a titanium oxide. For example, it is possible to use a titanium-containing oxide composed of a compound such as Li₂TiO₃, Li₄Ti₅O₁₂, or TiO₂, or a mixture thereof.

The titanium-containing oxide may be sintered on a surface of the lithium-containing transition metal oxide in the following manner. Predetermined amounts of the lithium-containing transition metal oxide and the titanium-containing oxide are mixed using mechanofusion or the like to attach the titanium-containing oxide onto the surface of the lithium-containing transition metal oxide, and thereafter, the mixture is sintered. It should be noted that when the titanium-containing oxide is sintered on a surface of the lithium-containing transition metal oxide, it is preferable that the sintering temperature be a temperature lower than the decomposition temperature of the lithium-containing transition metal oxide.

If the particle size of the positive electrode active material is too large, the discharge performance degrades. On the other hand, if the particle size is too small, the reactivity of the material with the non-aqueous electrolyte solution is too high, and the storage performance and so forth degrade. Therefore, it is preferable that primary particles of the positive electrode active material have a volume average particle size of from 0.5 μm to 2 μm, and that secondary particles of the positive electrode active material have a volume average particle size of from 5 μm to 15 μm.

In non-aqueous electrolyte secondary battery of the present invention, it is possible that the above-described positive electrode active material may be used in combination with another positive electrode active material. The other positive electrode active material that may be used in combination is not particularly limited as long as it is a compound that can reversibly intercalate and deintercalate lithium. For example, it is preferable to use ones having a layered structure, a spinel-type structure, or an olivine-type structure, which can intercalate and deintercalate lithium while keeping a stable crystal structure.

In the non-aqueous electrolyte secondary battery of the present invention, the negative electrode active material used for the negative electrode is not particularly limited as long as it can reversibly intercalate and deintercalate lithium. Examples include carbon materials, metal or alloy materials that can be alloyed with lithium, and metal oxides. From the viewpoint of material cost, it is preferable to use a carbon material as the negative electrode active material. Examples include natural graphite, artificial graphite, mesophase pitch-based carbon fiber (MCF), mesocarbon microbead (MCMB), coke, hard carbon, fullerenes, and carbon nanotube. From the viewpoint of improving high-rate charge-discharge capability, it is particularly preferable to use a carbon material in which a graphite material is covered with a low crystallinity carbon.

In the non-aqueous electrolyte secondary battery of the present invention, the non-aqueous solvent used for the non-aqueous electrolyte solution may be any known commonly-used non-aqueous solvent that has been used for non-aqueous electrolyte secondary batteries. Examples include cyclic carbonates such as ethylene carbonate, propylene carbonate, butylene carbonate and vinylene carbonate, and chain carbonates such as dimethyl carbonate, methyl ethyl carbonate, and diethyl carbonate. In particular, it is preferable to use a mixed solvent of a cyclic carbonate and a chain carbonate, as a non-aqueous solvent that has a low viscosity and a low melting point and shows high lithium ion conductivity. In this mixed solvent, it is preferable that the volume ratio of cyclic carbonate and chain carbonate be within the range of from 2/8 to 5/5.

It is also possible to use an ionic liquid as the non-aqueous solvent of the non-aqueous electrolyte solution. In this case, the cationic species and the anionic species are not particularly limited, but from the viewpoints of low viscosity, electrochemical stability, and hydrophobicity, it is preferable to use a combination in which the cation is a pyridinium cation, imidazolium cation, and quaternary ammonium cation, and the anion is a fluorine-containing imide-based anion.

In the present invention, the solute of the non-aqueous electrolyte may be any lithium salt that is commonly used as a solute in non-aqueous electrolyte secondary batteries. Such a lithium salt may be a lithium salt containing at least one element among P, B, F, O, S, N, and Cl. Specific examples of the lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(C₂F₅SO₂)₃, LiAsF₆, and LiClO₄, and mixtures thereof. It is particularly preferable to use LiPF₆, in order to enhance the high-rate charge-discharge capability and durability of the non-aqueous electrolyte secondary battery.

In the non-aqueous electrolyte secondary battery of the present invention, the separator interposed between the positive electrode and the negative electrode may be made of any material as long as it can prevent the short circuiting resulting from contact between the positive electrode and the negative electrode and it also can obtain lithium ion conductivity when being impregnated with a non-aqueous electrolyte solution. Examples include a polypropylene separator, a polyethylene separator, and a polypropylene-polyethylene multi-layered separator.

### EXAMPLES

Hereinbelow, examples of the non-aqueous electrolyte secondary battery according to the present invention will be described in detail along with comparative examples, and it will be demonstrated that the examples of the non-aqueous electrolyte secondary battery according to the invention achieve reduction in the resistance of the positive electrode active material. It should be construed that the non-aqueous electrolyte secondary battery according to the present invention is not limited to the following examples, but various changes and modifications are possible without departing from the scope of the invention.

### Example 1

In Example 1, a positive electrode active material was prepared as follows. Li₂CO₃ was mixed with Ni_{0.50}Mn_{0.50}(OH)₂ obtained by coprecipitation at a predetermined ratio, and the resultant mixture was sintered at 1000° C. in the air so that two elements, Ni and Mn, were the main components of the transition metal elements as shown in the following formula. The resultant layered Li_{1.06}Ni_{0.47}Mn_{0.47}O₂ was used as the lithium-containing metal oxide represented by the foregoing general formula. In the Li_{1.06}Ni_{0.47}Mn_{0.47}O₂ thus obtained, the primary particles had a volume average particle size of about 1 μm, and the secondary particles had a volume average particle size of about 7 μm.

The Li_{1.06}Ni_{0.47}Mn_{0.47}O₂ was mixed with TiO₂ having an average particle size of 50 nm at a predetermined ratio, and thereafter, the mixture was sintered at 700° C. in the air, to prepare a positive electrode active material in which a Ti-containing oxide was sintered on the surface of the Li_{1.06}Ni_{0.47}Mn_{0.47}O₂. The amount of titanium in the positive electrode active material thus prepared was 0.24 mass %.

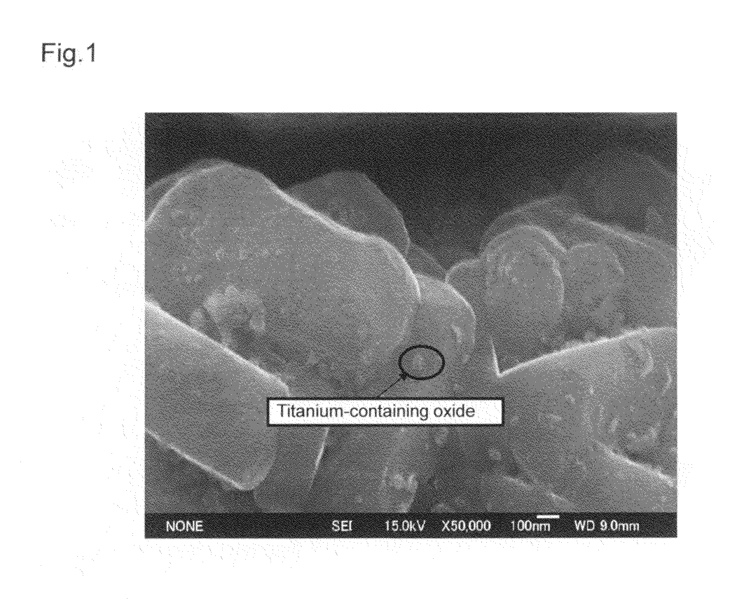

The positive electrode active material prepared in the above-described manner was observed with a scanning electron microscope (SEM). The result is shown in FIG. 1.

As a result, it was confirmed that, in this positive electrode active material, microparticles of the Ti-containing oxide having an average particle size of about 50 nm were sintered on the surface of the Li_{1.06}Ni_{0.47}Mn_{0.47}O₂ so that they were dispersed and adhered on the surface substantially uniformly. Here, it is believed that the microparticles adhering on the surface were composed of the source material TiO₂, a lithium-titanium oxide such as Li₂TiO₃ or Li₄Ti₅O₁₂ that was produced by the reaction between the TiO₂ and the lithium on the surface of the Li_{1.06}Ni_{0.47}Mn_{0.47}O₂, or a mixture thereof.

Next, the just-described positive electrode active material, vapor grown carbon fibers (VGCF) serving as a conductive agent, and a N-methyl-2-pyrrolidone solution in which polyvinylidene fluoride serving as a binder agent was dissolved in an amount of 8 wt % were prepared in a mass ratio of 92:5:3, and they were kneaded to prepare a positive electrode mixture slurry. The resultant positive electrode slurry was applied onto a positive electrode current collector made of an aluminum foil and then dried. Thereafter, the resultant article was pressure-rolled with pressure rollers, and an aluminum current collector tab was attached thereto. Thus, a positive electrode was prepared.

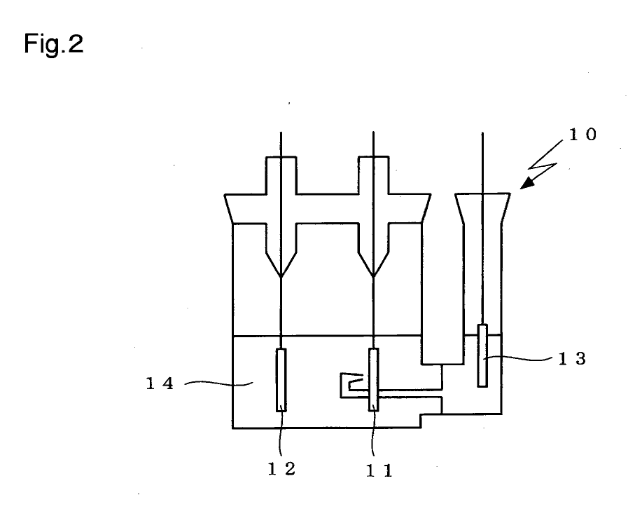

Then, a three-electrode test cell 10 as illustrated in FIG. 2 was prepared using the following components. The positive electrode prepared in the above-described manner was used as a working electrode 11. Metallic lithium was used for a counter electrode 12, serving as the negative electrode, and a reference electrode 13. A non-aqueous electrolyte solution 14 used was prepared as follows. LiPF₆ was dissolved at a concentration of 1 mol/L into a mixed solvent of ethylene carbonate, methyl ethyl carbonate, and dimethyl carbonate in a volume ratio of 3:3:4, and further, vinylene carbonate was dissolved therein in an amount of 1 mass %. Thus, the three-electrode test cell 10 was prepared.

### Example 2

In Example 2, a positive electrode active material was prepared in the same manner described as in Example 1 above, except that the amount of TiO₂ having an average particle size of 50 nm, which was mixed with Li_{1.06}Ni_{0.47}Mn_{0.47}O₂, was made greater. Using the positive electrode active material prepared in this manner, a positive electrode and a three-electrode test cell were prepared in the same manner as described in Example 1 above.

The amount of titanium in the positive electrode active material prepared in the above-described manner was 0.48 mass %.

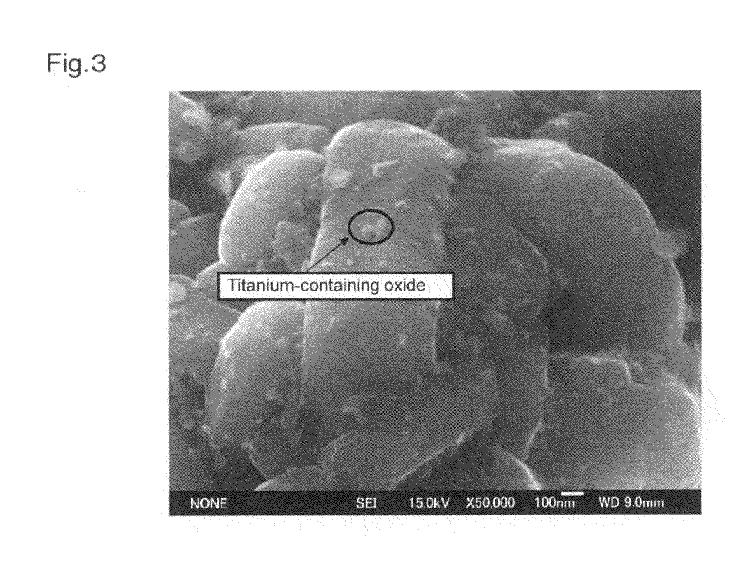

The positive electrode active material prepared in the above-described manner was observed with a scanning electron microscope (SEM). The result is shown in FIG. 3.

As a result, it was confirmed that, in the positive electrode active material of Example 2 as well, microparticles of the Ti-containing oxide having an average particle size of about 50 nm were sintered on the surface of the Li_{1.06}Ni_{0.47}Mn_{0.47}O₂ so that they were dispersed and adhered on the surface substantially uniformly, as in the case of the positive electrode active material of Example 1 above. In addition, in the positive electrode active material of Example 2, the amount of the Ti-containing oxide adhering to the surface of the Li_{1.06}Ni_{0.47}Mn_{0.47}O₂ was greater than that in the positive electrode active material of Example 1.

### Example 3

In Example 3, a positive electrode active material was prepared in the same manner as described in Example 1, except that Li_{1.06}Ni_{0.56}Mn_{0.38}O₂ containing primary particles with a volume average particle size of about 1 μm and secondary particles with a volume average particle size of about 7 μm was used as the lithium-containing metal oxide, to prepare a positive electrode active material in which a Ti-containing oxide was sintered on the surface of Li_{1.06}Ni_{0.56}Mn_{0.38}O₂. The amount of titanium in the positive electrode active material thus prepared was 0.24 mass %.

Using the positive electrode active material prepared in this manner, a positive electrode and a three-electrode test cell were fabricated in the same manner as described in Example 1 above.

### Example 4

In Example 4, a positive electrode active material was prepared in the same manner as described in Example 1, except that Li_{1.06}Ni_{0.46}Mn_{0.46}Co_{0.02}O₂ containing primary particles with a volume average particle size of about 1 μm and secondary particles with a volume average particle size of about 7 μm was used as the lithium-containing metal oxide, to prepare a positive electrode active material in which a Ti-containing oxide was sintered on the surface of Li_{1.06}Ni_{0.46}Mn_{0.46}Co_{0.02}O₂. The amount of titanium in the positive electrode active material thus prepared was 0.24 mass %.

Using the positive electrode active material prepared in this manner, a positive electrode and a three-electrode test cell were fabricated in the same manner as described in Example 1 above.

### Example 5

In Example 5, a positive electrode active material was prepared in the same manner as described in Example 1, except that Li_{1.06}Ni_{0.45}Mn_{0.45}Co_{0.04}O₂ containing primary particles with a volume average particle size of about 1 μm and secondary particles with a volume average particle size of about 7 μm was used as the lithium-containing metal oxide, to prepare a positive electrode active material in which a Ti-containing oxide was sintered on the surface of Li_{1.06}Ni_{0.45}Mn_{0.45}Co_{0.04}O₂. The amount of titanium in the positive electrode active material thus prepared was 0.24 mass %.

Using the positive electrode active material prepared in this manner, a positive electrode and a three-electrode test cell were fabricated in the same manner as described in Example 1 above.

### Example 6

In Example 6, a positive electrode active material was prepared in the same manner as described in Example 1, except that Li_{1.06}Ni_{0.43}Mn_{0.43}Co_{0.08}O₂ containing primary particles with a volume average particle size of about 1 μm and secondary particles with a volume average particle size of about 7 μm was used as the lithium-containing metal oxide, to prepare a positive electrode active material in which a Ti-containing oxide was sintered on the surface of Li_{1.06}Ni_{0.43}Mn_{0.43}Co_{0.08}O₂. The amount of titanium in the positive electrode active material thus prepared was 0.24 mass %.

Using the positive electrode active material prepared in this manner, a positive electrode and a three-electrode test cell were fabricated in the same manner as described in Example 1 above.

### Example 7

In Example 7, a positive electrode active material was prepared in the same manner as described in Example 1, except that Li_{1.06}Ni_{0.38}Mn_{0.38}Co_{0.18}O₂ containing primary particles with a volume average particle size of about 1 μm and secondary particles with a volume average particle size of about 7 μm was used as the lithium-containing metal oxide, to prepare a positive electrode active material in which a Ti-containing oxide was sintered on the surface of Li_{1.06}Ni_{0.38}Mn_{0.38}Co_{0.18}O₂. The amount of titanium in the positive electrode active material thus prepared was 0.24 mass %.

Using the positive electrode active material prepared in this manner, a positive electrode and a three-electrode test cell were fabricated in the same manner as described in Example 1 above.

### Comparative Example 1

In Comparative Example 1, a positive electrode active material was prepared in the same manner as described in Example 1 above, except that the Li_{1.06}Ni_{0.47}Mn_{0.47}O₂ alone was used as the positive electrode active material without mixing the TiO₂ having an average particle size of 50 nm therewith. Using the positive electrode active material prepared in this manner, a positive electrode was prepared, and also, using the positive electrode prepared in this manner, a three-electrode test cell was prepared in the same manner as described in Example 1 above.

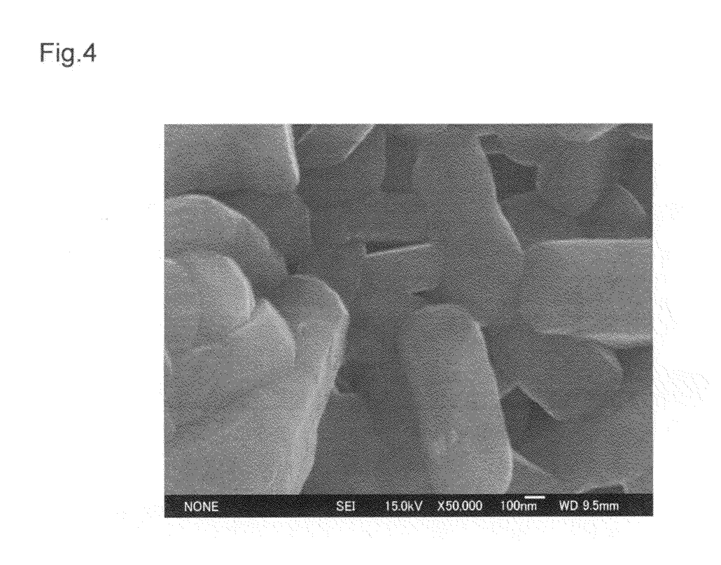

Here, the positive electrode active material comprising the Li_{1.06}Ni_{0.47}Mn_{0.47}O₂ alone was observed with a scanning electron microscope (SEM). The result is shown in FIG. 4.

### Comparative Example 2

In Comparative Example 2, a positive electrode active material was prepared in the same manner as described in Example 1 above, except that a simple mixture in which the Li_{1.06}Ni_{0.47}Mn_{0.47}O₂ and the TiO₂ having an average particle size of 50 nm were mixed in a predetermined ratio was used as the positive electrode active material. Using the positive electrode active material prepared in this manner, a positive electrode was prepared, and also, using the positive electrode prepared in this manner, a three-electrode test cell was prepared in the same manner as described in Example 1 above.

### Comparative Example 3

In Comparative Example 3, a positive electrode active material was prepared in the same manner as described in Example 1 above, except for the following. Li₂CO₃, TiO₂ having an average particle size of 50 nm, and Ni_{0.50}Mn_{0.50}(OH)₂ obtained by coprecipitation were mixed in a predetermined ratio, and the mixture was sintered at 1000° C. in the air, to prepare a positive electrode in which Ti was contained in the inside of Li_{1.06}Ni_{0.47}Mn_{0.47}O₂. Using the positive electrode active material prepared in this manner, a positive electrode was prepared, and also, using the positive electrode prepared in this manner, a three-electrode test cell was prepared in the same manner as described in Example 1 above.

The amount of titanium in the positive electrode active material prepared in this Comparative Example 3 was 0.24 mass %.

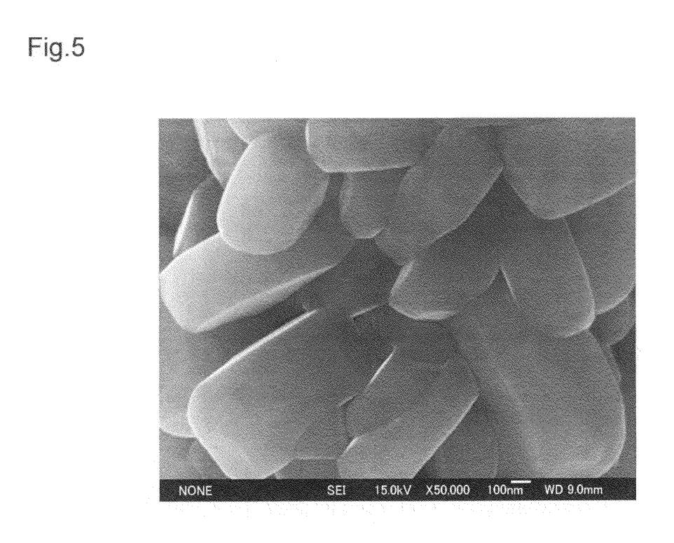

The positive electrode active material prepared in this Comparative Example 3 was observed with a scanning electron microscope (SEM). The result is shown in FIG. 5.

The result demonstrates that in positive electrode active material of this Comparative Example 3, Ti was incorporated in the inside of Li_{1.06}Ni_{0.47}Mn_{0.47}O₂, and no Ti-containing oxide was adhered on the surface of the Li_{1.06}Ni_{0.47}Mn_{0.47}O₂, as in the case of the positive electrode active material of Comparative Example 1, which comprised Li_{1.06}Ni_{0.47}Mn_{0.47}O₂ alone.

### Comparative Example 4

In Comparative Example 4, a positive electrode active material was prepared in the same manner as described in Example 1 above, except that the same Li_{1.06}Ni_{0.56}Mn_{0.38}O₂ as used in Example 3 above, in which the primary particles had a volume average particle size of about 1 μm and the secondary particles had a volume average particle size of about 7 μm, was used as the lithium-containing metal oxide, and that the Li_{1.06}Ni_{0.56}Mn_{0.38}O₂ alone was used as the positive electrode active material without mixing the TiO₂ having an average particle size of 50 nm therewith. Using the positive electrode active material prepared in this manner, a positive electrode was prepared, and also, using the positive electrode prepared in this manner, a three-electrode test cell was prepared in the same manner as described in Example 1 above.

### Comparative Example 5

In Comparative Example 5, a positive electrode active material was prepared in the same manner as described in Example 1 above, except that the same Li_{1.06}Ni_{0.46}Mn_{0.46}Co_{0.02}O₂ as used in Example 4 above, in which the primary particles had a volume average particle size of about 1 μm and the secondary particles had a volume average particle size of about 7 μm, was used as the lithium-containing metal oxide, and that the Li_{1.06}Ni_{0.46}Mn_{0.46}Co_{0.02}O₂ alone was used as the positive electrode active material without mixing the TiO₂ having an average particle size of 50 nm therewith. Using the positive electrode active material prepared in this manner, a positive electrode was prepared, and also, using the positive electrode prepared in this manner, a three-electrode test cell was prepared in the same manner as described in Example 1 above.

### Comparative Example 6

In Comparative Example 6, a positive electrode active material was prepared in the same manner as described in Example 1 above, except that the same Li_{1.06}Ni_{0.45}Mn_{0.45}Co_{0.04}O₂ as used in Example 5 above, in which the primary particles had a volume average particle size of about 1 μm and the secondary particles had a volume average particle size of about 7 μm, was used as the lithium-containing metal oxide, and that the Li_{1.06}Ni_{0.45}Mn_{0.45}Co_{0.04}O₂ alone was used as the positive electrode active material without mixing the TiO₂ having an average particle size of 50 nm therewith. Using the positive electrode active material prepared in this manner, a positive electrode was prepared, and also, using the positive electrode prepared in this manner, a three-electrode test cell was prepared in the same manner as described in Example 1 above.

### Comparative Example 7

In Comparative Example 7, a positive electrode active material was prepared in the same manner as described in Example 1 above, except that the same Li_{1.06}Ni_{0.43}Mn_{0.43}Co_{0.08}O₂ as used in Example 6 above, in which the primary particles had a volume average particle size of about 1 μm and the secondary particles had a volume average particle size of about 7 μm, was used as the lithium-containing metal oxide, and that the Li_{1.06}Ni_{0.43}Mn_{0.43}Co_{0.08}O₂ alone was used as the positive electrode active material without mixing the TiO₂ having an average particle size of 50 nm therewith. Using the positive electrode active material prepared in this manner, a positive electrode was prepared, and also, using the positive electrode prepared in this manner, a three-electrode test cell was prepared in the same manner as described in Example 1 above.

### Comparative Example 8

In Comparative Example 8, a positive electrode active material was prepared in the same manner as described in Example 1 above, except that the same Li_{1.06}Ni_{0.38}Mn_{0.38}Co_{0.18}O₂ as used in Example 7 above, in which the primary particles had a volume average particle size of about 1 μm and the secondary particles had a volume average particle size of about 7 μm, was used as the lithium-containing metal oxide, and that the Li_{1.06}Ni_{0.38}Mn_{0.38}Co_{0.18}O₂ alone was used as the positive electrode active material without mixing the TiO₂ having an average particle size of 50 nm therewith. Using the positive electrode active material prepared in this manner, a positive electrode was prepared, and also, using the positive electrode prepared in this manner, a three-electrode test cell was prepared in the same manner as described in Example 1 above.

### Comparative Example 9

In Comparative Example 9, Ni_{0.35}Mn_{0.30}Co_{0.35}O₂ prepared by coprecipitation and Li₂CO₃ were mixed in a predetermined ratio, and the mixture was sintered at 900° C. in the air, to prepare a lithium-containing transition metal oxide comprising Li_{1.06}Ni_{0.33}Mn_{0.28}Co_{0.33}O₂, containing a large amount of cobalt. In the Li_{1.06}Ni_{0.33}Mn_{0.28}Co_{0.33}O₂ thus obtained, the primary particles had a volume average particle size of about 1 μm, and the secondary particles had a volume average particle size of about 12 μm.

Next, the Li_{1.06}Ni_{0.33}Mn_{0.28}Co_{0.33}O₂ was mixed with TiO₂ having an average particle size of 50 nm at a predetermined ratio, and thereafter, the mixture was sintered at 700° C. in the air, to prepare a positive electrode active material in which a Ti-containing oxide was sintered on the surface of the Li_{1.06}Ni_{0.33}Mn_{0.28}Co_{0.33}O₂. The amount of titanium in the positive electrode active material thus prepared was 0.05 mass %.

Using the positive electrode active material prepared in this manner, a positive electrode was prepared, and also using the positive electrode prepared in this manner, a three-electrode test cell was fabricated in the same manner as described in Example 1 above.

### Comparative Example 10

In Comparative Example 10, a positive electrode active material was prepared in the same manner as described in Example 1 above, except that the lithium-containing transition metal oxide comprising Li_{1.06}Ni_{0.33}Mn_{0.28}Co_{0.33}O₂, containing a large amount of cobalt, as prepared in Comparative Example 9 above, was used alone as the positive electrode active material without mixing the TiO₂ having an average particle size of 50 nm therewith. Using the positive electrode active material prepared in this manner, a positive electrode was prepared, and also, using the positive electrode prepared in this manner, a three-electrode test cell was prepared in the same manner as described in Example 1 above.

Next, the I-V resistance at 10% state of charge (SOC) during discharge and the I-V resistance at 90% state of charge (SOC) during charge were determined for each of the three-electrode test cells made in the manners described in Examples 1 to 7 and Comparative Examples 1 to 10. The results are shown in Table 1 below.

Here, the I-V resistance during discharge at 10% state of charge (SOC) was determined in the following manner. The rated capacity was obtained for each of the three-electrode test cells. Each of the cells was charged to 10% of the rated capacity and rested for 10 minutes. Thereafter, the open circuit voltage at 10% state of charge (SOC) was obtained.

Subsequently, the sample cells were discharged at current densities of 0.08 mA/cm², 0.4 mA/cm², 0.8 mA/cm², and 1.6 mA/cm² for 10 seconds, and the battery voltages (vs. Li/Li⁺) were obtained at 10 seconds after the discharge. The battery voltages at respective current densities during discharge were plotted to determine the I-V profile of each of the three-electrode test cells. From the gradient of the straight line obtained, the I-V resistance during discharge at 10% state of charge (SOC) was obtained for each of the three-electrode test cells.

In addition, the I-V resistance during charge at 90% state of charge (SOC) was determined in the following manner. Each of the cells was charged to 90% of the rated capacity and rested for 10 minutes. Thereafter, the open circuit voltage at 90% state of charge (SOC) was obtained.

Subsequently, the sample cells were charged at current densities of 0.08 mA/cm², 0.4 mA/cm², 0.8 mA/cm², and 1.6 mA/cm² for 10 seconds, and the battery voltages (vs. Li/Li⁺) were obtained at 10 seconds after the charge. The battery voltages at the respective current densities during charge were plotted to determine the I-V profile of each of the three-electrode test cells. From the gradient of the straight line obtained, the I-V resistance during charge at 10% state of charge (SOC) was obtained for each of the three-electrode test cells.

TABLE 1

| | Positive electrode active material | | I-V resistance (Ω) | |
|---|---|---|---|---|
| | Li-containing transition | Amount of | 10% SOC | 90% SOC |
| | metal oxide | titanium (Condition) | during discharge | during charge |
| Ex. 1 | Li_{1.06}Ni_{0.47}Mn_{0.47}O₂ | 0.24 mass % | 15.5 | 6.1 |
| | | (surface sintered) | | |
| Ex. 2 | Li_{1.06}Ni_{0.47}Mn_{0.47}O₂ | 0.24 mass % | 18.4 | 4.8 |
| | | (surface sintered) | | |
| Ex. 3 | Li_{1.06}Ni_{0.56}Mn_{0.38}O₂ | 0.24 mass % | 14.2 | 3.9 |
| | | (surface sintered) | | |
| Ex. 4 | Li_{1.06}Ni_{0.46}Mn_{0.46}Co_{0.02}O₂ | 0.24 mass % | 15.6 | 5.9 |
| | | (surface sintered) | | |
| Ex. 5 | Li_{1.06}Ni_{0.45}Mn_{0.45}Co_{0.04}O₂ | 0.24 mass % | 15.4 | 5.3 |
| | | (surface sintered) | | |
| Ex. 6 | Li_{1.06}Ni_{0.43}Mn_{0.43}Co_{0.08}O₂ | 0.24 mass % | 14.9 | 3.9 |
| | | (surface sintered) | | |
| Ex. 7 | Li_{1.06}Ni_{0.38}Mn_{0.38}Co_{0.18}O₂ | 0.24 mass % | 16.7 | 2.3 |
| | | (surface sintered) | | |
| Comp. | Li_{1.06}Ni_{0.47}Mn_{0.47}O₂ | — | 18.7 | 15.3 |
| Ex. 1 | | | | |
| Comp. | Li_{1.06}Ni_{0.47}Mn_{0.47}O₂ | 0.24 mass % | 18.7 | 15.3 |
| Ex. 2 | | (mixture) | | |
| Comp. | Li_{1.06}Ni_{0.47}Mn_{0.47}O₂ | 0.24 mass % | 18.8 | 15.3 |
| Ex. 3 | | (incorporation) | | |
| Comp. | Li_{1.06}Ni_{0.56}Mn_{0.38}O₂ | — | 14.1 | 4.8 |
| Ex. 4 | | | | |
| Comp. | Li_{1.06}Ni_{0.46}Mn_{0.46}Co_{0.02}O₂ | — | 18.9 | 12.7 |
| Ex. 5 | | | | |
| Comp. | Li_{1.06}Ni_{0.45}Mn_{0.45}Co_{0.04}O₂ | — | 19.4 | 12.0 |
| Ex. 6 | | | | |
| Comp. | Li_{1.06}Ni_{0.43}Mn_{0.43}Co_{0.08}O₂ | — | 18.9 | 8.0 |
| Ex. 7 | | | | |
| Comp. | Li_{1.06}Ni_{0.38}Mn_{0.38}Co_{0.18}O₂ | — | 18.3 | 3.3 |
| Ex. 8 | | | | |
| Comp. | Li_{1.06}Ni_{0.33}Mn_{0.28}Co_{0.33}O₂ | 0.05 mass % | 4.8 | 1.6 |
| Ex. 9 | | (surface sintered) | | |
| Comp. | Li_{1.06}Ni_{0.33}Mn_{0.28}Co_{0.33}O₂ | — | 5.0 | 1.6 |
| Ex. 10 | | | | |

The results demonstrate the following. First, the three-electrode test cells of Examples 1 to 7 and Comparative Examples 1 to 8, which used lithium-containing transition metal oxides that satisfy the foregoing conditions of the general formula Li₁₊ₓNiₐMn_{b}Co_{c}O_{2+d}, were compared. The three-electrode test cells of Examples 1 through 7 showed only small decreases in the I-V resistance during discharge at a low state of charge, i.e., at 10% state of charge, but they exhibited significant decreases in the I-V resistance during charge at a high state of charge, i.e., at 90% state of charge. It should be noted that each of the Examples 1 to 7 used a positive electrode active material in which a titanium-containing oxide was sintered and adhered on the surface of the lithium-containing transition metal oxide. On the other hand, each of Comparative Examples 1 and 4 to 8 used positive electrode active materials comprising only the lithium-containing transition metal oxide, Comparative Example 2 used a positive electrode active material in which TiO₂ was merely mixed with the lithium-containing transition metal oxide comprising Li_{1.06}Ni_{0.47}Mn_{0.47}O₂, and Comparative Example 3 used a positive electrode active material in which titanium was incorporated in the lithium-containing transition metal oxide comprising Li_{1.06}Ni_{0.47}Mn_{0.47}O₂.

Thus, it is understood that the resistance of the input side is significantly reduced at a high state of charge in Examples 1 to 7, each of which uses a positive electrode active material in which a titanium-containing oxide is adhered to the lithium-containing transition metal oxide that satisfies the foregoing conditions of the foregoing general formula Li₁₊ₓNiₐMn_{b}Co_{c}O_{2+d} by sintering. Therefore, they can utilize the regenerative brake energy efficiently, so they can be suitably utilized for a power source for electric vehicles and the like.

In addition, the three-electrode test cells of Comparative Examples 9 and 10 were compared, each of which used the lithium-containing transition metal oxide Li_{1.06}Ni_{0.33}Mn_{0.28}Co_{0.33}O₂, which contained a large amount of cobalt and the composition ratio c of cobalt Co, the composition ratio a of nickel Ni, and the composition ratio b of manganese Mn did not satisfy the condition 0≦c/(a+b)<0.35. Almost no difference in the I-V resistance during discharge at 10% state of charge and in the I-V resistance during charge at 90% state of charge was observed between the three-electrode test cell of Comparative Example 9 and the three-electrode test cell of Comparative Example 10. Note that the three-electrode test cell of Comparative Example 9 used the positive electrode active material in which a titanium-containing oxide was adhered to the surface of the Li_{1.06}Ni_{0.33}Mn_{0.28}Co_{0.33}O₂ by sintering, and the three-electrode test cell of Comparative Example 10 used the positive electrode active material comprising Li_{1.06}Ni_{0.33}Mn_{0.28}Co_{0.33}O₂ alone.

Thus, it is demonstrated that the advantageous effect of significantly reducing the resistance of the input side particularly at a high state of charge in the case of using a positive electrode active material in which the titanium-containing oxide is adhered on the surface of the lithium-containing transition metal oxide by sintering is unique to the case in which the lithium-containing transition metal oxide has a small cobalt content and satisfies the conditions shown in the general formula.

### Example 8

In Example 8, a positive electrode active material was prepared in the same manner as described in Example 1, except that Li_{1.06}Ni_{0.52}Mn_{0.42}O₂ containing primary particles with a volume average particle size of about 1 μm and secondary particles with a volume average particle size of about 7 μm was used as the lithium-containing metal oxide, to prepare a positive electrode active material in which a Ti-containing oxide was sintered on the surface of Li_{1.06}Ni_{0.52}Mn_{0.42}O₂. The amount of titanium in the positive electrode active material thus prepared was 0.24 mass %.

Using the positive electrode active material prepared in this manner, a positive electrode and a three-electrode test cell were fabricated in the same manner as described in Example 1 above.

### Comparative Example 11

In Comparative Example 11, a positive electrode active material was prepared in the same manner as described in Example 1, except for the use of the following Li_{1.06}Ni_{0.66}Mn_{0.28}O₂ as the lithium-containing metal oxide. In the Li_{1.06}Ni_{0.66}Mn_{0.28}O₂, the primary particles had a volume average particle size of about 1 μm, the secondary particles had a volume average particle size of about 7 μm, and the a/b ratio according to the foregoing general formula Li₁₊ₓNiₐMn_{b}Co_{c}O_{2+d} was 2.3. Using this Li_{1.06}Ni_{0.66}Mn_{0.28}O₂, a positive electrode active material in which a Ti-containing oxide was sintered on the surface of Li_{1.06}Ni_{0.66}Mn_{0.28}O₂ was prepared. The amount of titanium in the positive electrode active material thus prepared was 0.24 mass %.

Using the positive electrode active material prepared in this manner, a positive electrode and a three-electrode test cell were fabricated in the same manner as described in Example 1 above.

Next, the three-electrode test cells of Examples 1, 3, and 8 and Comparative Example 11 were charged until the potential of each of the positive electrodes became 4.3 V versus the reference electrode, and thereafter, the positive electrode active materials were peeled off from the respective positive electrodes.

Then, 5 mg of the sample of each of the positive electrode active materials that was peeled off in the above manner and 3 mg of the non-aqueous electrolyte solution used for the three-electrode test cells were placed in an aluminum container and heated to cause the positive electrode active material to react with the non-aqueous electrolyte solution, to determine the temperature at which the heat generation reaches a peak (exothermic peak temperature). The results are shown in Table 2 below.

TABLE 2

| | | | | Exothermic |
|---|---|---|---|---|
| | Positive electrode active material | | | peak |
| | Li-containing | Amount of titanium | | temperature |
| | transition metal oxide | (Condition) | a/b | (° C.) |
| Ex. 1 | Li_{1.06}Ni_{0.47}Mn_{0.47}O₂ | 0.24 mass % | 1.0 | 305 |
| | | (surface sintered) | | |
| Ex. 8 | Li_{1.06}Ni_{0.52}Mn_{0.42}O₂ | 0.24 mass % | 1.2 | 298 |
| | | (surface sintered) | | |
| Ex. 3 | Li_{1.06}Ni_{0.56}Mn_{0.38}O₂ | 0.24 mass % | 1.5 | 296 |
| | | (surface sintered) | | |
| Comp. | Li_{1.06}Ni_{0.66}Mn_{0.28}O₂ | 0.24 mass % | 2.3 | 224 |
| Ex. 11 | | (surface sintered) | | |

The results demonstrate the following. The positive electrode active materials that employ a lithium-containing metal oxide in which the a/b value in the general formula Li₁₊ₓNiₐMn_{b}Co_{c}O_{2+d} is from 0.7 to 2.0, as shown in Examples 1, 3, and 8, exhibit higher temperatures at which the heat generation caused by the positive electrode active material reacting with the non-aqueous electrolyte solution reaches a peak than the positive electrode active material of Comparative Example 11, which uses a lithium-containing metal oxide with an a/b ratio exceeding 2.0, specifically, an a/b ratio of 2.3. Thus, the positive electrode active materials of Examples 1, 3, and 8 prevented the heat generation caused by the reaction of the positive electrode active material with the non-aqueous electrolyte solution even at high temperatures, and they showed significant improvements in thermal stability of the positive electrode active material.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

What is claimed is:

1. A method of manufacturing a non-aqueous electrolyte secondary battery which includes:
a positive electrode containing a positive electrode active material;
a negative electrode containing a negative electrode active material; and
a non-aqueous electrolyte solution in which a solute is dissolved in a non-aqueous solvent, wherein
the positive electrode active material comprises a layered lithium-containing transition metal oxide having a titanium-containing oxide sintered on a surface thereof, the layered lithium-containing transition metal oxide being represented by the general formula Li₁₊ₓNiₐMn_{b}Co_{c}O_{2+d}, wherein x, a, b, c, and d satisfy the following conditions x+a+b+c=1, 0.7≦a+b, 0<x≦0.1, 0≦c/(a+b)<0.35, 0.7≦a/b≦2.0, and −0.1≦d≦0.1;
the method comprising mixing the layered lithium-containing transition metal oxide with a Ti oxide; and sintering the mixture to obtain the positive electrode active material.

2. The method of manufacturing a non-aqueous electrolyte secondary battery according to claim 1, wherein, on the positive electrode active material, the amount of the titanium, in terms of titanium in the titanium-containing oxide, is from 0.05 mass % to 0.5 mass %.

3. The method of manufacturing a non-aqueous electrolyte secondary battery according to claim 1, wherein primary particles of the positive electrode active material have a volume average particle size of from 0.5 μm to 2 μm, and secondary particles of the positive electrode active material have a volume average particle size of from 5 μm to 15 μm.

4. The method of manufacturing a non-aqueous electrolyte secondary battery according to claim 1,
wherein the non-aqueous solvent of the non-aqueous electrolyte solution is a mixed solvent containing cyclic carbonate and chain carbonate in a volume ratio of from 2:8 to 5:5.
